(19) United States
(12) Patent Application Publication
(10) Pub. No.: US 2014/0027069 A1
(43) Pub. Date: Jan. 30, 2014

(54) Photovoltaic Blind

(71) Applicant: ILAND GREEN TECHNOLOGIES SA, Neuchatel (CH)

(72) Inventor: Daniele Oppizzi, Neuchatel (CH)

(73) Assignee: ILAND GREEN TECHNOLOGIES SA, Neuchatel (CH)

(21) Appl. No.: 13/827,807

(22) Filed: Mar. 14, 2013

(30) Foreign Application Priority Data
Jul. 24, 2012 (CH) 1113/12

(51) Int. Cl. E06B 9/40

(52) U.S. Cl. CPC E06B 9/40
USPC 160/6; 160/127; 160/120

(57) ABSTRACT

The invention relates to a photovoltaic blind (1) comprising a rotating drum (2) and several flexible photovoltaic panels (10-12) that can be rolled up and unrolled around this rotating drum to close respectively unfold the blind. The device comprises a ventilation tube (19) and a ventilator (190) powered by the photovoltaic panels in order to create an air flux under the photovoltaic blind.

The present application claims priority of Swiss patent application CH2012/1113, filed on Jul. 24, 2012, the contents of which is hereby enclosed by reference.

### TECHNICAL FIELD

The present invention relates to a photovoltaic blinds/roller shutter, in particular a rollable photovoltaic blind with flexible photovoltaic panels.

The invention relates in particular to a joint-arm blind designed to be fastened onto a building wall, for example to protect a terrace from the sun, and which can be either rolled into a cassette mounted against or inside the wall or unfolded obliquely above the terrace. Such blinds are also known under the name of standout blinds, awnings or canopies, depending on the type of arm connecting the roller blind header to the cassette.

### STATE OF THE ART

It is already known in the state of the art to use the surface of blinds to produce electricity.

EP1845218A2 describes a motorized blind with photovoltaic panels mounted onto the box into which the blind is rolled up. The surface available for the solar cells is limited and the produced energy therefore reduced.

A similar solution is also described in EP2453073A1 and in EP0916781B1.

DE20000681U1 describes a motorized photovoltaic blind with solar cells mounted on the loadbar at the distal extremity of the blind, in order notably to power lamps under the blind. A weather station is provided on the blind's cassette. Again, the surface available for the photovoltaic cells is very reduced. Furthermore, the electric connection between the photoelectric cells and the blind's motor or the other electricity-consuming devices requires cables under the blind, which risk being torn off.

WO2006/072819A1 describes an awning photo-generator in the form of flexible cloth or of an arrangement of bars, wherein practically the entire surface of the blind is used for producing electricity.

EP2434070A1 describes a blind provided with an electric energy producing system in the form of a flexible panel, with electric connecting means for connecting the panel to the outside of the blind. A similar solution is also described in DE202009005U1.

Despite the shade created by the blind, the temperature in the shaded zone is often very high. The blind also protects against the wind and limits the air drafts under the blind. The air heated by the fabric exposed to the sun thus tends to stagnate under the blind, so that the temperature quickly rises.

### BRIEF SUMMARY OF THE INVENTION

One aim of the present invention is to propose a photovoltaic blind free from these limitations.

According to the invention, these aims are achieved notably by means of a photovoltaic blind having the characteristics of claim 1.

According to one aspect, the photovoltaic blind comprises a rotating drum and several flexible photovoltaic panels that can be rolled up or unrolled around this drum to close resp. unfold the blind. A ventilation tube and a ventilator powered by the photovoltaic panels are furthermore provided in order to create an air flux under the photovoltaic blind.

This ventilation tube and this ventilator enable an air flux to be generated under the blind in order to avoid the accumulation of hot air and to reduce the perceived sensation of heat.

The hot air tends to accumulate in particular at the highest point under the blind, i.e. directly under the blind's cassette, at the junction between the wall and the blind. In order to evacuate in particular this hot air, the ventilation tube preferably extends substantially over the entire length of the drum and of the blind and comprises a plurality of nozzles to ventilate under the entire width of the photovoltaic blind.

The ventilation tube is preferably lodged in or directly under the cassette enabling the rotating drum to also be stored with the rolled up blind.

A first temperature sensor can be provided for measuring the temperature under the photovoltaic blind. A control electronics in the cassette of the blind or connected to the blind can be provided to control the ventilator according to the temperature measured by the first temperature-measuring sensor. It is thus possible to adapt the level of ventilation to the temperature and to avoid for example excessive ventilation if the temperature under the blind is low. A second temperature sensor can be provided for measuring the temperature above the photovoltaic blind. The sensor can also be connected to an inside heating or air conditioning management of a house and provide thermal information on its regulation, for example in order to adapt the heating and/or air conditioning of the house to the measurements performed by the second sensor and/or also by the first sensor.

The control electronics can also be arranged for controlling the ventilator so as to vary the level of ventilation continuously or according to more than two levels depending on the current and/or voltage produced by the photovoltaic panels. It is thus possible to anticipate a temperature increase whenever the solar illumination becomes significant or to reduce the ventilation as soon as this illumination decreases. The generated current measurement can be weighted by taking into account the surface of the panels effectively exposed to the sun and thus of the length unrolled.

A motor can be provided for driving the rotating drum. The control electronics can be arranged for controlling the electric motor so as to automatically roll up or unroll the photovoltaic blind depending on at least one sensor. It is for example possible to control the unfolding or folding back of the blind depending on the signals supplied by an anemometer, a rain gauge and/or an accelerometer connected to the loadbar of the blind, in order for example to fold back the blind automatically, in case of strong winds.

A day/night sensor, based for example on the measured light intensity and/or on a real-time clock circuit, can also be provided in order to program the automatic rolling up of the blind during the night and its unrolling as soon as it is day and the luminosity is sufficient to produce electricity.

The blind can comprise at least one electric cable allowing the current produced by the photovoltaic panels to be transmitted towards the outside of the photovoltaic blind, in order to inject this electricity into the electric grid or to power apparatus close to the blind. At least one portion of the electric cable can extend in a parallel fashion to the rotating drum. A rotating electric connector can be mounted at one extremity of the rotating drum. The cable can traverse a longitudinal opening through the rotating drum. Each photovoltaic panel can be connected to two electric cables.

An electronic charge regulation system and a battery can be arranged for storing the electric current produced by the photovoltaic panels. An inverter can be provided for converting the direct electric current produced by the photovoltaic panels into alternating current.

A system for cutting off the direct current electric connection can be provided in order to interrupt the electric current circulation in the portion of circuit where direct currents flow. This system can be actuated remotely from a control outside said cassette. This makes it possible for instance to interrupt the current flow and the possible fire or electrocution hazards which could be caused by the flow of considerable direct currents in a blind left unattended. This remote control can for example be accessible from the entrance to the building, in order also to allow the fire brigade or rescue services to interrupt the production of electricity as close as possible to the photovoltaic panels. The remote control can be connected to the switch in the direct current circuit by means of a wired or wireless connection. The switch in the direct current circuit can be constituted by a relay or a power transistor.

In order to prevent excessive direct currents from circulating, individual circuit breakers can be provided in each branch formed of photovoltaic panels connected serially and/or in parallel.

### BRIEF DESCRIPTION OF THE FIGURES

Examples of embodiments of the invention are given in the description illustrated by the attached figures in which:

FIG. 1 illustrates a diagrammatic view from above of a photovoltaic blind according to the invention.

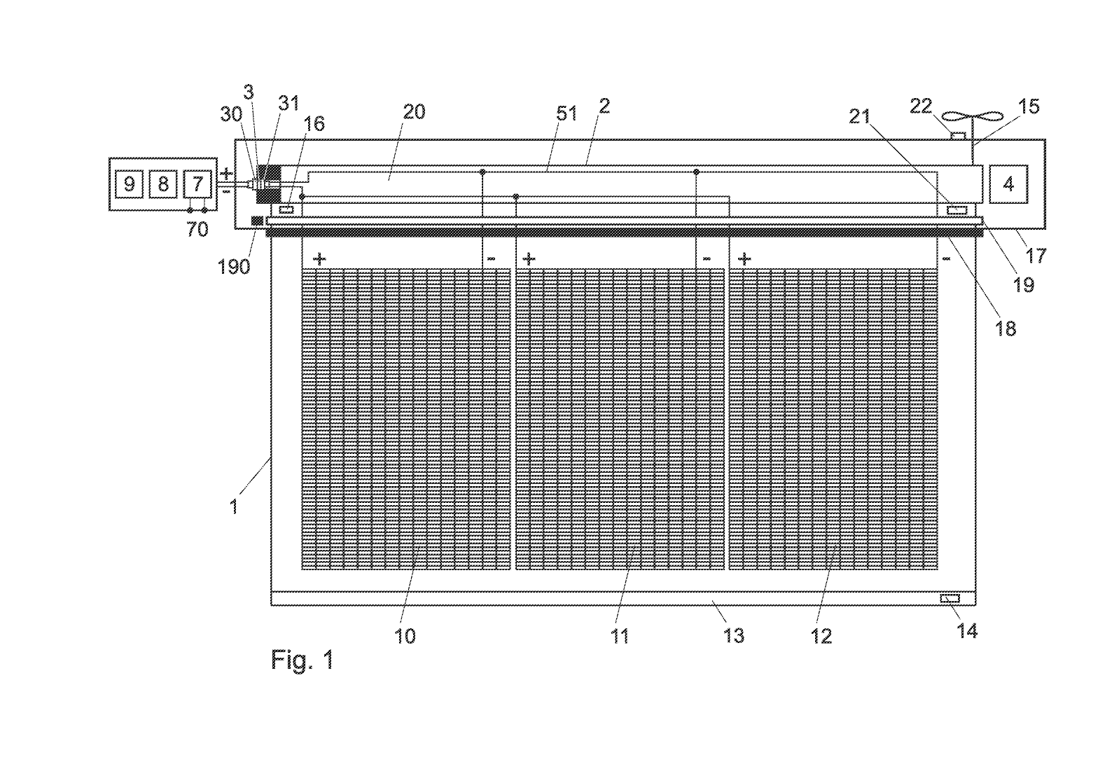

FIG. 2 illustrates a cross-section view of the photovoltaic blind of FIG. 1.

### EXAMPLE(S) OF EMBODIMENTS OF THE INVENTION

The photovoltaic blind 1 illustrated in the figures comprises a cloth onto which are mounted one or several flexible photovoltaic panels, in this example three panels 10 to 12 that can be welded to one another or glued onto a support. A greater number of panels can be provided. A loadbar 13 is mounted on the distal extremity of the blind, whose weight tends to make the blind unroll. The blind can be rolled or unrolled around a rotating drum 2, or roller, for example manually by means of a bar, not represented, and/or by means of an electric motor at one of the ends of the rotating drum 2. Arms, not represented, are advantageously provided under the blind in order to stretch out the cloth between the axis 2 and the loadbar 13, for example joint-arms at each left-right end of the cloth or horizontal arms from the loadbar towards the wall.

The rotating drum 2 at the proximal extremity of the photovoltaic blind 1 is mounted in a cassette 17, for example a stainless steel cassette, designed to be fastened against a wall or within a wall. An opening in the cassette 17 allows the cloth to come out of the cassette. The motor 4 can also be lodged in the cassette.

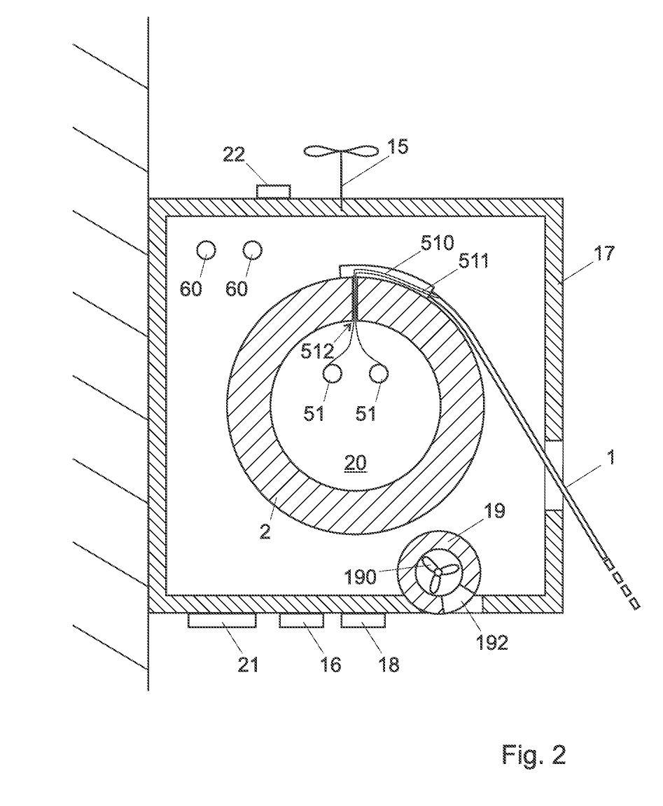

The rotating drum 2 is advantageously provided with an opening 20 in the longitudinal direction of the drum, as can be seen in FIG. 2. Each photovoltaic panel 10-12 produces an electric current and is connected electrically to two flexible electric cables 510, 511 that penetrate into the longitudinal opening 20 through radial openings 512 in the wall of the rotating drum 2. The cables 510, 511 of the different panels 10-12 are connected to one another serially, in parallel or by placing several strips in parallel in order to form a two-phased longitudinal cable 51 that traverses the opening 20 in the drum. A safety circuit breaker can be provided on each panel or serial group of panels in order to ensure that the maximum current in each branch of the circuit does not exceed a threshold value (for example a value between 2 and 3 amperes) beyond which the short-circuit is triggered.

One end of the drum 2, for example the end opposite the one equipped with the motor 4, is provided with a rotating connector 3. The connector 3 comprises a mobile part 31 that can turn with the rotating drum 2 and a fixed part 30 connected to the housing 17. Sliding electric contacts enable an electric connection between the cables 51 and fixed electric or electronic components 7, 8, 9 to be established. By using a rotating connector 3, it is possible to avoid torsion of the cables 51 in the drum when the latter turns.

The photovoltaic blind 1 is furthermore advantageously provided with or connected to an electronic charge regulation circuit 7 for monitoring the charge of an optional battery 8 enabling the generated current to be stored. The energy stored in the battery can for example be used for rolling the blind electrically even if there is a power cut and/or when the fire brigade cuts the grid for safety reasons. Alternatively, or additionally, the photovoltaic blind 1 can be provided with or connected to an inverter 7, or a DC-to-AC converter, in order to convert the low DC voltage supplied by the photovoltaic panels in parallel into a higher alternating voltage, for example 110 or 230 V, which can for example be injected into the electric grid. Reference 70 designates an electric power supply socket enabling an alternating 110 or 230 V voltage to be supplied to power electric apparatus. Sockets supplying a direct voltage can also be provided for powering small apparatus, for example a USB-format power supply socket for powering an audio apparatus or a telephone, etc. The voltage supplied by the alternator can also be injected into the electric grid, for example by means of a manual and automatic circuit breaker enabling the photovoltaic installation to be disconnected either at will or when the values of the voltage or of the current generated are outside a predetermined range.

Reference 7 designates schematically an electronic control circuit for controlling one or several of the following functions:
automatic rolling or unrolling of the blind by means of the engine 4, using the battery 8 or the grid;
lighting under the blind by means of lamps 18, for example a row of LED lamps under the blind 1;
ventilation under the blind by means of a ventilator 190 and of a ventilation tube 19.
triggering an anti-mosquito repellent device, for example an ultrasound device 16.

The ventilation under the blind is advantageously achieved by means of a ventilator 190 producing an air flux in a ventilation tube 19 in or under the blind's cassette 17. The ventilation tube 19 preferably extends over the entire length of the blind 1, close to the highest point of the zone shaded by the blind. The ventilation tube 19 is provided with several nozzles 192, or with a long longitudinal opening, for blowing air from inside the tube 19 towards this zone. The nozzles can be constituted by simple holes in the tube 19.

The control electronics is arranged for controlling the ventilator so as to vary the level of ventilation continuously or according to more than two levels depending on the current and/or on the voltage produced by the photovoltaic panels 10-12 and/or on the temperature under the blind measured by the sensor 21 and/or on the temperature above the blind measured by the sensor 21 and/or on the wind measured by the anemometer and/or on the unrolled length of the blind. Advantageously, the level of ventilation depends first and foremost on the instantaneous temperature measured by the temperature sensor 21 under the blind, the illumination measured with the panels 10-12 being used as an additional signal interpreted in combination with the unrolled portion of the blind, in order to anticipate a temperature rise in advance.

The photovoltaic blind 1 can furthermore be provided with one or several sensors for supplying signals to the control electronics 9 in order to enable this electronics to determine when and how the blind must be rolled up or unrolled, when and how the lamps 18 must be lit, as well as when and how the ventilation should be actuated. These decisions can depend on one or several of the following sensors or elements:
An anemometer 15 on the cassette 17 enables the wind speed to be measured, in order for example to roll up the blind automatically to prevent it from being destroyed in case of strong wind and/or to interrupt the ventilation when the wind is already significant and to adapt the level of ventilation to the speed of the wind.
Alternatively, or additionally, an accelerometer 14 can be mounted on the loadbar 13, in order to detect the movements of this loadbar that can be caused by strong wind and confirm or replace the decisions taken depending on the anemometer 15. This accelerometer can be connected to the control electronics 9 for example by means of electric wires (not represented) welded to the cloth or through the tension arms of the blind. Alternatively, this accelerometer can be connected to the electronics 9 over a wireless interface, for example a Bluetooth, Zigbee or proprietary interface. It can be powered by an independent photovoltaic sensor.
A rain gauge (not represented) can be provided for rolling up the blind in case of a shower or rainfall above a certain level.
a temperature sensor 21 makes it possible to measure the temperature under the blind 1. This sensor can for example be mounted against the cassette 17 or inside this cassette.
A temperature sensor 22 can also be provided for measuring the temperature above the blind 1, preferably in a shaded area but above the blind.
The photovoltaic panels 10-12 themselves can be used as illumination sensors. The intensity of the current generated can be measured and used by the control electronics 9 to determine the level of sunshine and adapt for example the ventilation depending on this level of sunshine. This enables for example a temperature rise under the blind 1 to be anticipated before it occurs.
The intensity of the current generated by the panels 10-12 also depends on the length of the unrolled portion of these panels; even in case of bright luminosity, the current will be less if the blind is not totally unrolled. Consequently, the radial position of the motor 4, corresponding to the length of the portion of the unrolled blind, can also be used in combination with the intensity of the generated current to control the intensity of the ventilation, the necessity of rolling up or unrolling the blind as well as the lamps 18. A radial position sensor can be used to determine the length of blind unrolled.
A time switch (not represented) can be integrated into the blind 1 or to the electronics 9 in order for example to automatically roll up or unroll the blind at certain times, to automatically switch on or off the lamps 18 and/or the ventilation 190 according to the time, or to automatically switch on/off the anti-mosquito device according to the time.
A night/day sensor can be provided, in addition to or in replacement of the time switch, for detecting the day and the night according to the light intensity, even when the blind is rolled up.
A wired or wireless remote control, not represented, can be used to control the unrolling or rolling up of the blind, the lighting of the lamps 18 and/or the ventilation according to the user's commands.

The control electronics 9 can advantageously be programmed or at least parameterized according to the particularities of each location and/or of the user's preferences. For example, the times of the day and of the night can be parameterized depending on the longitude and latitude.

The electronic load regulation circuit or inverter 7, the battery 8 and/or the control electronics can be lodged, completely or partly, in a portion of the blind's cassette 17 protected from humidity. These elements can also be accommodated, completely or partly, outside the blind's cassette 17.

Advantageously, at least the inverter 7 is installed inside the building, in a zone protected from humidity, for example at the point at which the electric grid enters into the building.

A system for cutting off the direct current electric connection can be provided in order to interrupt the current in the direct current portion of circuit. This emergency cut off is advantageously positioned as close to the photovoltaic panels as possible, for example on the cloth itself, in the drum 2 or in any case inside the cassette 17. It can comprise a relay or a power transistor. It can advantageously be actuated remotely from a control grouped with the device for switching off the blind or the building or placed in the immediate vicinity of the latter and specifically identifiable. Thus, it is possible to interrupt easily and as close to the panels as possible the direct electric currents inside the installation, from a distance.

Some sensors, for example sensors 10, 11, 12, 14 connected to the blind 1 or to the loadbar 13 can be connected to the electronics 9 by means of cables traversing the opening 20 in the rotating drum 2. Some sensors, for example the sensors 15, 21, 22, fixed relative to the blind's cassette 17, can be connected to the electronics 9 by means of cables 60 traversing the blind's cassette 17 outside this drum or by means of wireless connections (Bluetooth, Zigbee, WiFi, proprietary system, etc.).

In the same way, some electricity-consuming devices, for example the LED lamps 18 and the ventilator 190, can be connected to the electronics 9 by means of cables traversing the blind's cassette 17 outside the drum 2 or possibly through this drum.

The electronics 9, the motor 4 and the different sensors or electricity-consuming devices 14, 15, 16, 18, 19, 21, 22 are advantageously powered electrically by the photovoltaic panels 10-12, directly or indirectly over the charge regulation circuit 7, the battery 8 and the control electronics 9. This enables the photovoltaic blind 1 to function independently of any connection to an external electricity supply source. An electric connection can also be provided to power these functions when the panels do not generate any current and the battery 8 is not charged.

### REFERENCE NUMBERS USED IN THE FIGURES

1 photovoltaic blind
2 rotating drum
3 rotating electric connector
4 motor
7 charge regulation system and/or inverter
8 battery
9 control electronics
10-12 photovoltaic panels
13 loadbar
14 accelerometer
15 anemometer
16 anti-mosquito repellent device
17 cassette of the blind
18 LED lighting
19 ventilation tube
190 ventilator
20 longitudinal opening through said drum
21 inside temperature sensor
22 outside temperature sensor
30 fixed portion of the connector 3
31 rotating portion of the connector 3
51 data cables for the weather station, traversing the cassette longitudinally
60 control cables of the motor, traversing the cassette longitudinally
70 electric socket 12V or 110/220V

1. Photovoltaic blind comprising:
a rotating drum;
one or several flexible photovoltaic panels that can be rolled up and unrolled around this rotating drum to close respectively unfold the blind,
a ventilation tube and a ventilator in order to create an air flux under the photovoltaic blind.

2. Blind according to claim 1, wherein the ventilation tube extends substantially over the entire length of the rotating drum and comprises a plurality of nozzles for ventilating under the photovoltaic blind.

3. Blind according to claim 1, comprises a cassette enabling the rotating drum to be lodged with the rolled up blind and the ventilation tube below the rotating drum.

4. Blind according to claim 1, comprising a first temperature sensor for measuring the temperature under the photovoltaic blind and by a control electronics for controlling the ventilator according to the temperature measured by the first temperature sensor.

5. Blind according to claim 4, comprising a second temperature sensor for measuring the temperature above the photovoltaic blind.

6. Blind according to claim 4, wherein at least one said temperature sensor is connected to a regulating or heating system of a building.

7. Blind according to claim 4, wherein the control electronics is arranged for controlling the ventilator so as to vary the level of ventilation continuously or according to more than two levels depending on the current and/or voltage produced by the photovoltaic panels.

8. Blind according to claim 4, comprising a sensor for determining the unrolled length of the blind, wherein the control electronic is arranged for controlling the ventilator taking this length into account.

9. Blind according to claim 4, comprising a motor for driving the rotating drum as well as at least one sensor, the control electronics being arranged to control the electric motor so as to automatically roll up or unroll the photovoltaic blind according to said sensor or sensors.

10. Blind according to the preceding claim, wherein the sensor or sensors comprise an anemometer.

11. Blind according to claim 9, comprising a loadbar at the roller blind, wherein the sensor or sensors comprise an accelerometer mounted onto said loadbar.

12. Blind according to claim 1, comprising:
at least one electric cable enabling the current produced by the photovoltaic panels to be transmitted towards the outside of the photovoltaic blind,
at least one portion of the electric cable being parallel to the rotating drum,
a rotating electric connector being mounted at the end of the rotating drum.

13. Blind according to claim 12, wherein the electric cable traverses a longitudinal opening through the rotating drum.

14. Blind according to claim 12, wherein each photovoltaic panel is connected to two electric cables.

15. Blind according to claim 1, comprising a charge regulation system and a battery arranged for storing the electric current produced by the photovoltaic panels.

16. Blind according to claim 1, comprising an inverter for converting the direct electric current produced by the photovoltaic panels into alternating current.

17. Blind according to claim 1, comprising a cassette of the blind and a system for cutting off the direct current electric connection and which can be actuated remotely from a control device outside said cassette.

18. Blind according to claim 1, wherein said panels are connected to one another so as to form several branches connected in parallel, with a circuit breaker being mounted in each branch.
